(19) United States
(12) Patent Application Publication
(10) Pub. No.: US 2015/0356933 A1
(43) Pub. Date: Dec. 10, 2015

(54) DISPLAY DEVICE

(71) Applicant: Japan Display Inc., Tokyo (JP)

(72) Inventors: Masaaki Kabe, Tokyo (JP); Akira Sakaigawa, Tokyo (JP); Amane Higashi, Tokyo (JP)

(21) Appl. No.: 14/731,031

(22) Filed: Jun. 4, 2015

(30) Foreign Application Priority Data
Jun. 5, 2014 (JP) 2014-117105

(51) Int. Cl. G09G 3/36; G09G 3/20

(52) U.S. Cl. CPC G09G 3/3607; G09G 3/2003; G09G 3/2074; G09G 3/3648; G09G 2300/0452; G09G 2320/02

(57) ABSTRACT

According to an aspect, a display device includes: a display unit including a plurality of pixels arranged therein, the pixels including a first sub-pixel, a second sub-pixel, a third sub-pixel, and a fourth sub-pixel; and a signal processing unit that calculates output signals corresponding to the first sub-pixel, the second sub-pixel, the third sub-pixel, and the fourth sub-pixel based on input signals corresponding to the first sub-pixel, the second sub-pixel, and the third sub-pixel. The signal processing unit calculates each of the output signals based on a result obtained by extracting and analyzing only information on a certain region within one frame from the input signals.

### CROSS-REFERENCE TO RELATED APPLICATIONS

This application claims priority from Japanese Application No. 2014-117105, filed on Jun. 5, 2014, the contents of which are incorporated by reference herein in its entirety.

### BACKGROUND

1. Technical Field

The present invention relates to a display device.

2. Description of the Related Art

In recent years, demand has been increased for display devices for a mobile apparatus and the like, such as a cellular telephone and an electronic paper. In such display devices, one pixel includes a plurality of sub-pixels that output different colors. Various colors are displayed using one pixel by controlling a display state of the sub-pixels. Display characteristics such as resolution and display luminance have been improved year after year in such display devices. However, an aperture ratio is reduced as the resolution increases, so that luminance of a lighting apparatus such as a backlight and a front light needs to be increased to achieve high luminance in a case of using a non-self-luminous type display device such as a liquid crystal display device, which leads to increase in power consumption. To solve this problem, a technique has been developed for adding a white pixel serving as a fourth sub-pixel to red, green, and blue sub-pixels known in the art (for example, refer to Japanese Patent Application Laid-open Publication No. 2011-154323 (JP-A-2011-154323)). According to this technique, the white pixel enhances the luminance to lower a current value of the lighting apparatus and reduce the power consumption. In a case in which the current value of the backlight is not lowered, the luminance enhanced by the white pixel can be utilized to improve visibility under outdoor external light.

JP-A-2011-154323 discloses a display device including an image display panel in which pixels including a first, a second, a third, and a fourth sub-pixels are arranged in a two-dimensional matrix, and a signal processing unit that receives an input signal and outputs an output signal. The display device can expand an HSV (Hue-Saturation-Value, Value is also called Brightness) color space as compared with a case of three primary colors by adding the fourth color to the three primary colors. The signal processing unit stores maximum values Vmax(S) of brightness using saturation S as a variable, obtains a saturation S and a brightness V(S) based on a signal value of the input signal, obtains an expansion coefficient Δ0 based on at least one of values of Vmax(S)/V(S), obtains an output signal value for the fourth sub-pixel based on at least one of an input signal value to the first sub-pixel, an input signal value to the second sub-pixel, and an input signal value to the third sub-pixel, and calculates the respective output signal values to the first, the second, and the third sub-pixels based on the corresponding input signal value, the expansion coefficient Δ0, and the fourth output signal value. The signal processing unit then obtains the saturation S and the brightness V(S) of each of a plurality of pixels based on the input signal values for the sub-pixels in each of the pixels, and determines the expansion coefficient Δ0 so that a ratio of pixels in which a value of an expanded brightness obtained by multiplying the brightness V(S) by the expansion coefficient Δ0 exceeds the maximum value Vmax(S) to all pixels is equal to or smaller than a predetermined value. Accordingly, to determine the expansion coefficient Δ0, a population of pixels to be analyzed is assumed to be all pixels.

When a size of a display image is varied on a display screen, for example, when full-screen display is scaled down to be window display, the periphery of the display image may be surrounded with a black frame and the like to be identified. In this case, if the population of the pixels to be analyzed is assumed to be all pixels in determining the expansion coefficient Δ0, the expansion coefficient Δ0 is influenced and changed by information of a pixel for a frame part. Accordingly, even when the display image displayed on a full-screen is the same as the display image in the window, a display state may be varied, for example, the brightness may be changed corresponding to the change of the expansion coefficient Δ0.

For the foregoing reasons, there is a need for a display device that can achieve low power consumption without providing a feeling of strangeness to a viewer when scaling up or down a display image on a display screen. Also, there is a need for a display device that can achieve high display luminance without providing a feeling of strangeness to a viewer when scaling up or down a display image on a display screen.

### SUMMARY

According to an aspect, a display device includes: a display unit including a plurality of pixels arranged therein, the pixels including a first sub-pixel that displays a first color component, a second sub-pixel that displays a second color component, a third sub-pixel that displays a third color component, and a fourth sub-pixel that displays a fourth color component different from the first sub-pixel, the second sub-pixel, and the third sub-pixel; and a signal processing unit that calculates output signals corresponding to the first sub-pixel, the second sub-pixel, the third sub-pixel, and the fourth sub-pixel based on input signals corresponding to the first sub-pixel, the second sub-pixel, and the third sub-pixel. The signal processing unit calculates each of the output signals based on a result obtained by extracting and analyzing only information on a certain region within one frame from the input signals.

### BRIEF DESCRIPTION OF THE DRAWINGS

FIG. 1 is a block diagram illustrating an example of a configuration of a display device according to an embodiment;

FIG. 2 is a diagram illustrating a pixel array of an image display panel according to the embodiment;

FIG. 3 is a conceptual diagram of the image display panel and an image-display-panel drive circuit of the display device according to the embodiment;

FIG. 4 is a diagram illustrating another example of the pixel array of the image display panel according to the embodiment;

FIG. 5 is a conceptual diagram of an extended HSV color space that can be extended by the display device according to the embodiment;

FIG. 6 is a conceptual diagram illustrating a relation between hue and saturation in the extended HSV color space;

FIG. 7 is a conceptual diagram illustrating a relation between saturation and brightness in the extended HSV color space;

FIG. 8 is an explanatory diagram illustrating an image of an input signal, which is an example of information in one frame;

FIG. 9 is an explanatory diagram illustrating an image of the input signal, which is an example of the information in one frame;

FIG. 10 is an explanatory diagram illustrating a relation between information in the frame illustrated in FIG. 8 and information in the frame illustrated in FIG. 9;

FIG. 11 is a flowchart for explaining a processing procedure of color conversion processing according to the embodiment;

FIG. 12 is a block diagram illustrating another example of the configuration of the display device according to the embodiment;

FIG. 13 is a flowchart for explaining a processing procedure of color conversion processing according to a modification of the embodiment;

FIG. 14 is a diagram for explaining cumulative frequency distribution using an expansion coefficient as a variable when the information in one frame illustrated in FIG. 9 is displayed by each pixel;

FIG. 15 is a diagram for explaining cumulative frequency distribution using the expansion coefficient as a variable when the information in one frame illustrated in FIG. 8 is displayed by each pixel;

FIG. 16 is a diagram illustrating an example of an electronic apparatus including the display device according to the embodiment; and

FIG. 17 is a diagram illustrating an example of an electronic apparatus including the display device according to the embodiment.

### DETAILED DESCRIPTION

The following describes an embodiment in detail with reference to the drawings. The present invention is not limited to the embodiment described below. Components described below include a component that is easily conceivable by those skilled in the art and substantially the same component. The components described below can be appropriately combined. The disclosure is merely an example, and the present invention naturally encompasses an appropriate modification maintaining the gist of the invention that is easily conceivable by those skilled in the art. To further clarifying the description, a width, a thickness, a shape, and the like of each component may be schematically illustrated in the drawings as compared with an actual aspect. However, this is merely an example and interpretation of the invention is not limited thereto. The same element as that described in the drawing that has already been discussed is denoted by the same reference numeral through the description and the drawings, and detailed description thereof will not be repeated in some cases.

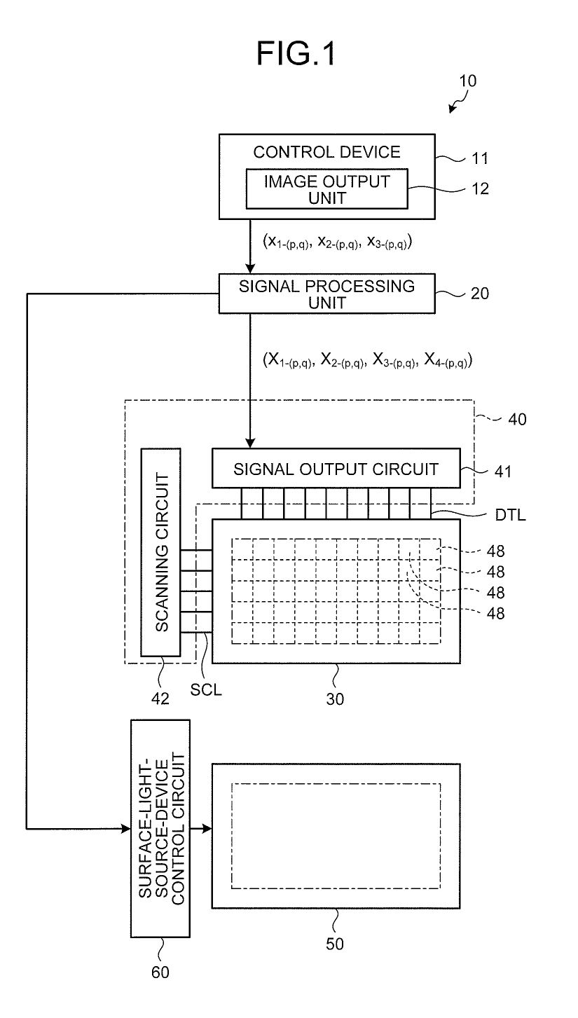

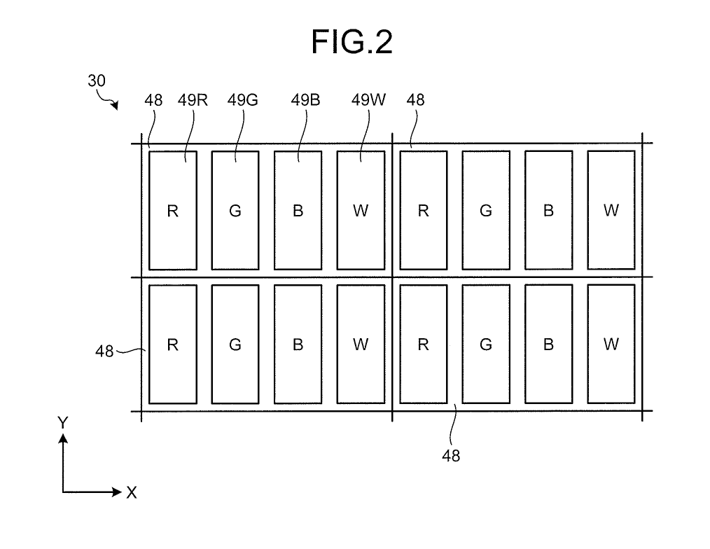

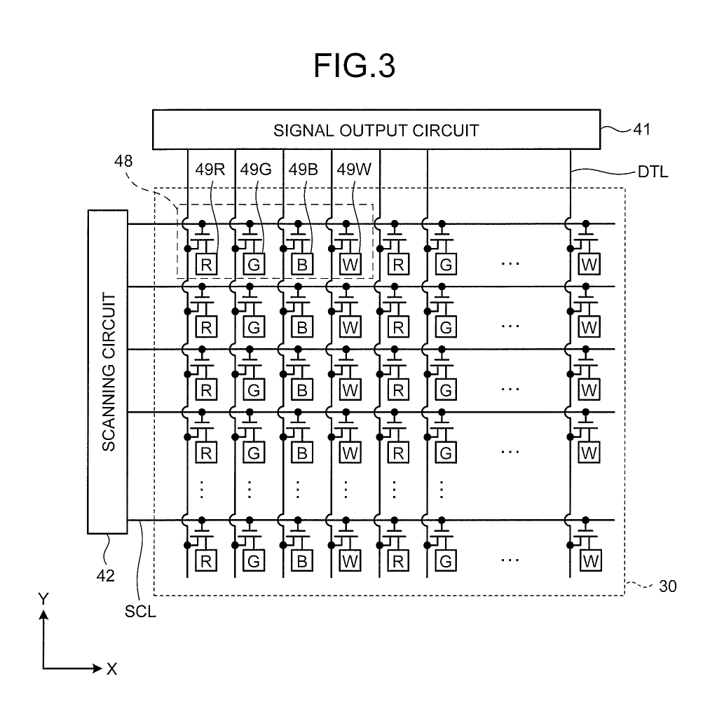

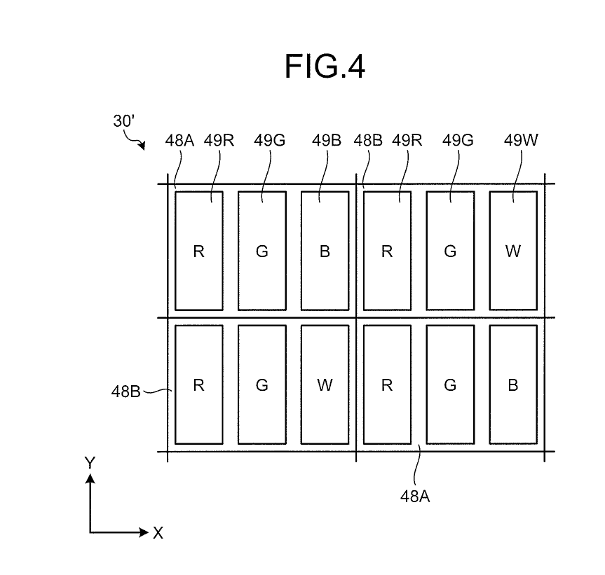

FIG. 1 is a block diagram illustrating an example of a configuration of a display device according to an embodiment. FIG. 2 is a diagram illustrating a pixel array of an image display panel according to the embodiment. FIG. 3 is a conceptual diagram of the image display panel and an image-display-panel drive circuit of the display device according to the embodiment. FIG. 4 is a diagram illustrating another example of the pixel array of the image display panel according to the embodiment.

As illustrated in FIG. 1, a display device 10 includes a signal processing unit 20 that receives an input signal (RGB data) from an image output unit 12 of a control device 11 and executes predetermined data conversion processing on the signal to be output, an image display panel 30 that displays an image based on an output signal output from the signal processing unit 20, an image-display-panel drive circuit 40 that controls the drive of an image display panel (display unit) 30, a surface light source device 50 that illuminates the image display panel 30 from its back surface, for example, and a surface-light-source-device control circuit 60 that controls the drive of the surface light source device 50. The display device 10 has the same configuration as that of an image display device assembly disclosed in JP-A-2011-154323, and various modifications described in JP-A-2011-154323 can be applied thereto.

The signal processing unit 20 synchronizes and controls operations of the image display panel 30 and the surface light source device 50. The signal processing unit 20 is coupled to the image display panel drive circuit 40 for driving the image display panel 30, and the surface-light-source-device control circuit 60 for driving the surface light source device 50. The signal processing unit 20 processes the input signal input from the outside to generate the output signal and a surface-light-source-device control signal. That is, the signal processing unit 20 virtually converts an input value (input signal) of an input signal in an input HSV color space into an extended value in an extended HSV color space extended with the first color, the second color, the third color, and the fourth color components to be generated, and outputs the output signal based on the extended value to the image display panel drive circuit 40. The signal processing unit 20 then outputs the surface-light-source-device control signal corresponding to the output signal to the surface-light-source-device control circuit 60.

As illustrated in FIGS. 2 and 3, pixels 48 are arranged in a two-dimensional matrix of P₀×Q₀ (P₀ in a row direction, and Q₀ in a column direction) in the image display panel 30. FIGS. 2 and 3 illustrate an example in which the pixels 48 are arranged in a matrix on an XY two-dimensional coordinate system. In this example, the row direction is the X-direction and the column direction is the Y-direction.

Each of the pixels 48 includes a first sub-pixel 49R, a second sub-pixel 49G, a third sub-pixel 49B, and a fourth sub-pixel 49W. The first sub-pixel 49R displays a first color component (for example, red as a first primary color). The second sub-pixel 49G displays a second color component (for example, green as a second primary color). The third sub-pixel 49B displays a third color component (for example, blue as a third primary color). The fourth sub-pixel 49W displays a fourth color component (specifically, white). In the following description, the first sub-pixel 49R, the second sub-pixel 49G, the third sub-pixel 49B, and the fourth sub-pixel 49W may be collectively referred to as a sub-pixel 49 when they are not required to be distinguished from each other. The image output unit 12 described above outputs RGB data, which can be displayed with the first color component, the second color component, and the third color component in the pixel 48, as the input signal to the signal processing unit 20.

More specifically, the display device 10 is a transmissive color liquid crystal display device, for example. The image display panel 30 is a color liquid crystal display panel in which a first color filter that allows the first primary color to pass through is arranged between the first sub-pixel 49R and an image observer, a second color filter that allows the second primary color to pass through is arranged between the second sub-pixel 49G and the image observer, and a third color filter that allows the third primary color to pass through is arranged between the third sub-pixel 49B and the image observer. In the image display panel 30, there is no color filter between the fourth sub-pixel 49W and the image observer. A transparent resin layer may be provided for the fourth sub-pixel 49W instead of the color filter. In this way, by arranging the transparent resin layer, the image display panel 30 can suppress occurrence of a large gap above the fourth sub-pixel 49W, otherwise the large gap occurs because of arranging no color filter for the fourth sub-pixel 49W.

In the example illustrated in FIG. 2, the first sub-pixel 49R, the second sub-pixel 49G, the third sub-pixel 49B, and the fourth sub-pixel 49W are arranged in a stripe-like pattern in the image display panel 30. A structure and an arrangement of the sub-pixels 49R, 49G, 49B, and 49W included in one pixel 48 are not specifically limited. For example, the first sub-pixel 49R, the second sub-pixel 49G, the third sub-pixel 49B, and the fourth sub-pixel 49W may be arranged in a diagonal-like pattern (mosaic-like pattern) in the image display panel 30. The arrangement may be a delta-like pattern (triangle-like pattern) or a rectangle-like pattern, for example. As in an image display panel 30′ illustrated in FIG. 4, a pixel 48A including the first sub-pixel 49R, the second sub-pixel 49G, and the third sub-pixel 49B and a pixel 48B including the first sub-pixel 49R, the second sub-pixel 49G, and the fourth sub-pixel 49W are alternately arranged in the row direction and the column direction.

Generally, the arrangement in the stripe-like pattern is preferable for displaying data or character strings on a personal computer and the like. In contrast, the arrangement in the mosaic-like pattern is preferable for displaying a natural image on a video camera recorder, a digital still camera, or the like.

The image display panel drive circuit 40 includes a signal output circuit 41 and a scanning circuit 42. In the image display panel drive circuit 40, the signal output circuit 41 holds video signals to be sequentially output to the image display panel 30. The signal output circuit 41 is electrically coupled to the image display panel 30 via wiring DTL. In the image display panel drive circuit 40, the scanning circuit 42 controls ON/OFF of a switching element (for example, a thin film transistor (TFT)) for controlling an operation of the sub-pixel (such as display luminance, in this case, light transmittance) in the image display panel 30. The scanning circuit 42 is electrically coupled to the image display panel 30 via wiring SCL.

The surface light source device 50 is arranged on a back surface of the image display panel 30, and illuminates the image display panel 30 by irradiating the image display panel 30 with light. The surface light source device 50 may be arranged on a front surface of the image display panel 30 as a front light. When a self-luminous display device such as an organic light emitting diode (OLED) display device is used as the image display panel 30, the surface light source device 50 is not required.

The surface light source device 50 irradiates the entire surface of the image display panel 30 with light to illuminate the image display panel 30. The surface-light-source-device control circuit 60 controls irradiation light quantity and the like of the light output from the surface light source device 50. Specifically, the surface-light-source-device control circuit 60 adjusts a duty ratio of a signal, a voltage, or an electric current to be supplied to the surface light source device 50 based on the surface-light-source-device control signal output from the signal processing unit 20 to control the irradiation light quantity (light intensity) of the light with which the image display panel 30 is irradiated. Next, the following describes a processing operation executed by the display device 10, more specifically, the signal processing unit 20.

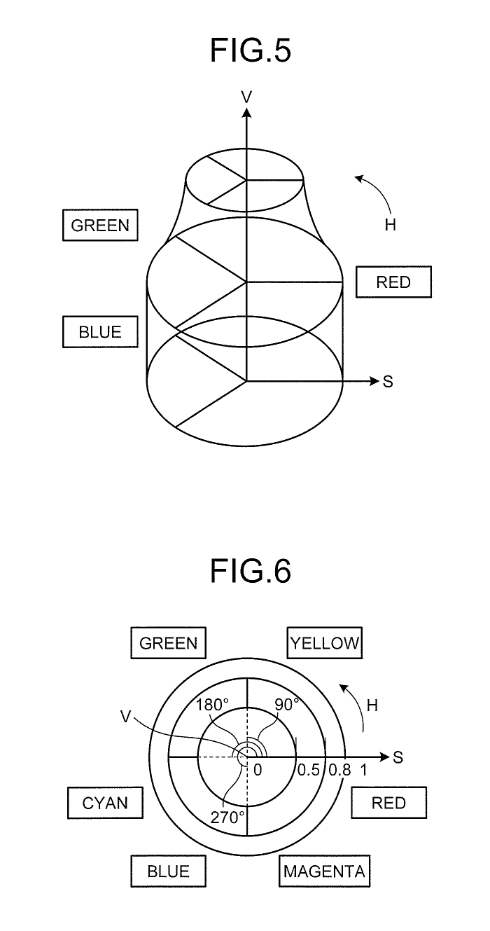

FIG. 5 is a conceptual diagram of the extended HSV color space that can be extended by the display device according to the embodiment. FIG. 6 is a conceptual diagram illustrating a relation between hue and saturation in the extended HSV color space. The signal processing unit 20 receives an input signal that is information on an image to be displayed and that is input from the outside. The input signal includes information on the image to be displayed at its position for each pixel. Specifically, in the image display panel 30 in which P₀×Q₀ pixels 48 are arranged in a matrix, with respect to the (p, q)-th pixel 48 (where 1≦p≦P₀, 1≦q≦Q₀), the signal processing unit 20 receives an input signal for the first sub-pixel 49R the signal value of which is x_{1-(p, q)}, an input signal for the second sub-pixel 49G the signal value of which is x_{2-(p, q)}, and an input signal for the third sub-pixel 49B the signal value of which is x_{3-(p, q)} (refer to FIG. 1).

The signal processing unit 20 illustrated in FIG. 1 processes the input signals to generate an output signal of the first sub-pixel for determining display gradation of the first sub-pixel 49R (signal value X_{1-(p, q)}), an output signal of the second sub-pixel for determining the display gradation of the second sub-pixel 49G (signal value X_{2-(p, q)}), an output signal of the third sub-pixel for determining the display gradation of the third sub-pixel 49B (signal value X_{3-(p, q)}), and an output signal of the fourth sub-pixel for determining the display gradation of the fourth sub-pixel 49W (signal value X_{4-(p, q)}) to be output to the image display panel drive circuit 40.

In the display device 10, the pixel 48 includes the fourth sub-pixel 49W for outputting the fourth color component (white) to widen a dynamic range of the brightness in the HSV color space (extended HSV color space) as illustrated in FIG. 5. That is, as illustrated in FIG. 5, a substantially truncated cone, in which the maximum value of brightness V is reduced as saturation S increases, is placed on a cylindrical HSV color space that can be displayed by the first sub-pixel 49R, the second sub-pixel 49G, and the third sub-pixel 49B.

The signal processing unit 20 stores maximum values Vmax(S) of brightness using saturation S as a variable in the HSV color space expanded by adding the fourth color component (white). That is, the signal processing unit 20 stores each maximum value Vmax(S) of brightness for each of coordinates (coordinate values) of saturation and hue regarding the three-dimensional shape of the HSV color space illustrated in FIG. 5. The input signals include the input signals of the first sub-pixel 49R, the second sub-pixel 49G, and the third sub-pixel 49B, so that the HSV color space of the input signals has a cylindrical shape, that is, the same shape as a cylindrical part of the extended HSV color space.

Next, the signal processing unit 20 determines an expansion coefficient α within a range not exceeding the extended HSV color space based on the input signals (x_{1-(p, q)}), x_{2-(p, q)}, and x_{3-(p, q)}) for one image display frame, for example. Accuracy may be improved by sampling all of the input signals (x_{1-(p, q)}, x_{2-(p, q)} and x_{3-(p, q)}), or circuit scale may be reduced by sampling part of the input signals. In each pixel 48, the input signal (signal value x_{1-(p, q)}) for the first sub-pixel 49R, the input signal (signal value x_{2-(p, q)}) for the second sub-pixel 49G, and the input signal (signal value x_{3-(p, q)}) for the third sub-pixel 49B that are input based on expanded image information (x_{1′-(p, q)}, x_{2′-(p, q)}, and x_{3′-(p, q)}) are converted into information indicating the output signal (signal value X_{1-(p, q)}) for the first sub-pixel 49R, the output signal (signal value X_{2-(p, q)}) for the second sub-pixel 49G, the output signal (signal value X_{3-(p, q)}) for the third sub-pixel 49B, and the output signal (signal value X_{4-(p, q)}) for the fourth sub-pixel 49W.

The signal processing unit 20 then calculates the output signal for the first sub-pixel 49R based on the expansion coefficient α for the first sub-pixel 49R and the output signal for the fourth sub-pixel 49W, calculates the output signal for the second sub-pixel 49G based on the expansion coefficient α for the second sub-pixel 49G and the output signal for the fourth sub-pixel 49W, and calculates the output signal for the third sub-pixel 49B based on the expansion coefficient α for the third sub-pixel 49B and the output signal for the fourth sub-pixel 49W.

That is, assuming that χ is a constant depending on the display device 10, the signal processing unit 20 obtains, from the following expressions (1) to (3), the signal value X_{1-(p, q)} as the output signal for the first sub-pixel 49R, the signal value X_{2-(p, q)} as the output signal for the second sub-pixel 49G, and the signal value X_{3-(p, q)} as the output signal for the third sub-pixel 49B, each of those signal values being output to the (p, q)-th pixel (or a group of the first sub-pixel 49R, the second sub-pixel 49G, and the third sub-pixel 49B).

X_{1-(p,q)}=α·x_{1-(p,q)}−χ·X_{4-(p,q)} (1)

X_{2-(p,q)}=α·x_{2-(p,q)}−χ·X_{4-(p,q)} (2)

X_{3-(p,q)}=α·x_{3-(p,q)}−χ·X_{4-(p,q)} (3)

The signal processing unit 20 obtains a maximum value Vmax(S) of brightness using saturation S as a variable in the HSV color space expanded by adding the fourth color, and obtains the saturation S and the brightness V(S) of each of a plurality of pixels based on the input signal values for the sub-pixels in each of the pixels. Then the expansion coefficient α is determined so that a ratio of pixels in which a value of an expanded brightness obtained by multiplying the brightness V(S) by the expansion coefficient α exceeds the maximum value Vmax(S) to all pixels is equal to or smaller than a limit value β.

The saturation S and the brightness V(S) are expressed as follows: S=(Max−Min)/Max, and V(S)=Max. The saturation S may take values of 0 to 1, the brightness V(S) may take values of 0 to (2ⁿ−1), and n is a display gradation bit number. Max is the maximum value among the input signal values for three sub-pixels, that is, the input signal value for the first sub-pixel, the input signal value for the second sub-pixel, and the input signal value for the third sub-pixel, each of those signal values being input to the pixel. Min is the minimum value among the input signal values of three sub-pixels, that is, the input signal value of the first sub-pixel, the input signal value of the second sub-pixel, and the input signal value of the third sub-pixel, each of those signal values being input to the pixel. Hue H is represented in a range of 0° to 360° as illustrated in FIG. 6. Arranged are red, yellow, green, cyan, blue, magenta, and red from 0° to 360°. In the embodiment, a region including an angle 0° is red, a region including an angle 120° is green, and a region including an angle 240° is blue.

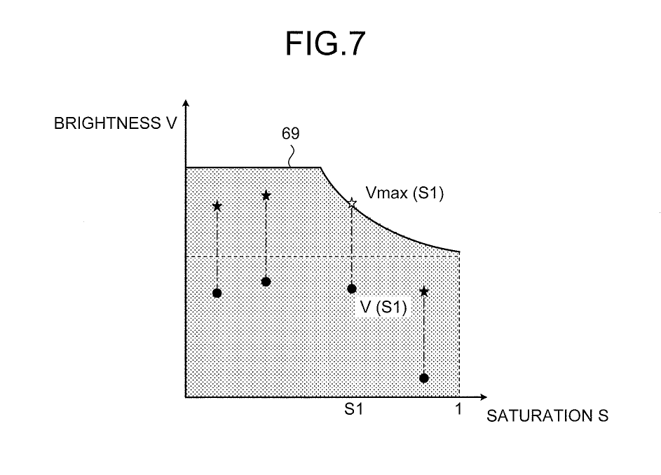

FIG. 7 is a conceptual diagram illustrating a relation between saturation and brightness in the extended HSV color space. A limit value line 69 illustrated in FIG. 7 indicates part of the maximum value of the brightness V in the cylindrical HSV color space that can be displayed with the first sub-pixel 49R, the second sub-pixel 49G, and the third sub-pixel 49B illustrated in FIG. 5. In FIG. 7, a circle mark indicates the value of the input signal, and a star mark indicates the expanded value. As illustrated in FIG. 7, the brightness V(S1) of the value in which the saturation is S1 is Vmax(S1) that is in contact with the limit value line 69.

According to the embodiment, the signal value X_{4-(p, q)} can be obtained based on a product of Min_{(p, q)} and the expansion coefficient α. Specifically, the signal value X_{4-(p, q)} can be obtained based on the following expression (4). In the expression (4), the product of Min_{(p, q)} and the expansion coefficient α is divided by χ. However, the embodiment is not limited thereto. χ will be described later. The expansion coefficient α is determined for each image display frame.

X_{4-(p,q)}=Min_{(p,q)}·α/χ (4)

Generally, in the (p, q)-th pixel, the saturation S_{(p, q)} and the brightness V(S)_{(p, q)} in the cylindrical HSV color space can be obtained from the following expressions (5) and (6) based on the input signal (signal value x_{1-(p, q)}) for the first sub-pixel 49R, the input signal (signal value x_{2-(p, q)}) for the second sub-pixel 49G, and the input signal (signal value x_{3-(p, q)}) for the third sub-pixel 49B.

S_{(p,q)}=(Max_{(p,q)}−Min_{(p,q)})/Max_{(p,q)} (5)

V(S)_{(p,q)}=Max_{(p,q)} (6)

In the above expressions, Max_{(p, q)} represents the maximum value among the input signal values for three sub-pixels 49 (x_{1-(p, q)}, x_{2-(p, q)}, and x_{3-(p, q)}), and Min_{(p, q)} represents the minimum value among the input signal values for three sub-pixels 49 (x_{1-(p, q)}, x_{2-(p, q)}, and x_{3-(p, q)}). In the embodiment, n is assumed to be 8. That is, the display gradation bit number is assumed to be 8 bits (a value of the display gradation is assumed to be 256 gradations, that is, 0 to 255).

No color filter is arranged for the fourth sub-pixel 49W that displays white. When a signal having a value corresponding to the maximum signal value of the output signal for the first sub-pixel is input to the first sub-pixel 49R, a signal having a value corresponding to the maximum signal value of the output signal for the second sub-pixel is input to the second sub-pixel 49G, and a signal having a value corresponding to the maximum signal value of the output signal for the third sub-pixel is input to the third sub-pixel 49B, luminance of an aggregate of the first sub-pixel 49R, the second sub-pixel 49G, and the third sub-pixel 49B included in a pixel 48 or a group of pixels 48 is assumed to be BN₁₋₃. When a signal having a value corresponding to the maximum signal value of the output signal for the fourth sub-pixel 49W is input to the fourth sub-pixel 49W included in a pixel 48 or a group of pixels 48, the luminance of the fourth sub-pixel 49W is assumed to be BN₄. That is, white having the maximum luminance is displayed by the aggregate of the first sub-pixel 49R, the second sub-pixel 49G, and the third sub-pixel 49B, and the luminance of the white is represented by BN₁₋₃. Assuming that χ is a constant depending on the display device 10, the constant χ is represented by χ=BN₄/BN₁₋₃.

Specifically, the luminance BN₄ when the input signal having a value of display gradation 255 is assumed to be input to the fourth sub-pixel 49W is 1.5 times the luminance BN₁₋₃ of white when it is assumed that the input signals having values of display gradation such as the signal value x_{1-(p, q)}=255, the signal value x_{2-(p, q)}=255, and the signal value x_{3-(p, q)}=255, are input to the aggregate of the first sub-pixel 49R, the second sub-pixel 49G, and the third sub-pixel 49B. In this embodiment, χ is assumed to be 1.5.

Vmax(S) can be represented by the following expressions (7) and (8).

When S≦S₀,

Vmax(S)=(χ+1)·(2ⁿ−1) (7)

When S₀<S≦1,

Vmax(S)=(2n−1)·(1/S) (8)

In this case, S₀=¹/(χ+1) is satisfied.

The thus-obtained maximum values Vmax(S) of brightness using saturation S as a variable in the HSV color space expanded by adding the fourth color component are stored in the signal processing unit 20 as a kind of look-up table, for example. Alternatively, the signal processing unit 20 calculates a maximum value Vmax(S) of brightness using saturation S as a variable in the expanded HSV color space as occasion demands.

Next, the following describes a method of obtaining the signal values X_{1-(p, q)}, X_{2-(p, q)}, X_{3-(p, q)}, and X_{4-(p, q)} as output signals for the (p, q)-th pixel 48 (expansion processing). The following processing is performed to keep a ratio among the luminance of the first primary color displayed by the input signal (signal value x1-(p, q)) for the first sub-pixel 49R, the luminance of the second primary color displayed by the input signal (signal value x2-(p, q)) for the second sub-pixel 49G, and the luminance of the third primary color displayed by the input signal (signal value x3-(p, q)) for the third sub-pixel 49B to be the same as a ratio among the luminance of the first primary color displayed by (first sub-pixel 49R+fourth sub-pixel 49W), the luminance of the second primary color displayed by (second sub-pixel 49G+fourth sub-pixel 49W), and the luminance of the third primary color displayed by (third sub-pixel 49B+fourth sub-pixel 49W). The processing is performed to also keep (maintain) color tone. In addition, the processing is performed to keep (maintain) a gradation-luminance characteristic (gamma characteristic, γ characteristic). When all of the input signal values are 0 or small values in any one of pixels 48 or any one of groups of pixels 48, the expansion coefficient α may be obtained without including such a pixel 48 or a group of pixels 48.

### First Process

First, the signal processing unit 20 obtains the saturation S and the brightness V(S) of each of the pixels 48 based on the input signal values for the sub-pixels 49 of the pixels 48. Specifically, S_{(p, q)} and V(S)_{(p, q)} are obtained from the expressions (5) and (6) based on the signal value x_{1-(p, q)} that is the input signal for the first sub-pixel 49R, the signal value x_{2-(p, q)} that is the input signal for the second sub-pixel 49G, and the signal value x_{3-(p, q)} that is the input signal for the third sub-pixel 49B, each of those signal values being input to the (p, q)-th pixel 48. The signal processing unit 20 performs this processing on all of the pixels 48, for example.

### Second Process

Next, the signal processing unit 20 obtains the expansion coefficient α(S) based on the Vmax(S)/V(S) obtained with respect to each of the pixels 48.

a(S)=Vmax(S)/V(S) (9)

Then the signal processing unit 20 arranges values of expansion coefficient α(S) obtained with respect to each of the pixels (all of P₀×Q₀ pixels in the embodiment) 48 in ascending order, for example, and determines the expansion coefficient α(S) corresponding to the position at the distance of β×P₀×Q₀ from the minimum value among the values of the P₀×Q₀ expansion coefficients α(S) as the expansion coefficient α. In this way, the expansion coefficient α can be determined so that a ratio of the pixels in which a value of an expanded brightness obtained by multiplying the brightness V(S) by the expansion coefficient α exceeds the maximum value Vmax(S) to all pixels is equal to or smaller than a predetermined value (β).

### Third Process

Next, the signal processing unit 20 obtains the signal value X_{4-(p, q)} for the (p, q)-th pixel 48 based on at least the expansion coefficient α(S) and the signal value x_{1-(p, q)}, the signal value x_{2-(p, q)}, and the signal value x_{3-(p, q)} of the input signals. In the embodiment, the signal processing unit 20 determines the signal value X_{4-(p, q)} based on Min_{(p, q)}, the expansion coefficient α, and the constant χ. More specifically, as described above, the signal processing unit 20 obtains the signal value X_{4-(p, q)} based on the expression (4). The signal processing unit 20 obtains the signal value X_{4-(p, q)} for all of the P₀×Q₀ pixels 48.

### Fourth Process

Subsequently, the signal processing unit 20 obtains the signal value X_{1-(p, q)} for the (p, q)-th pixel 48 based on the signal value x_{1-(p, q)}, the expansion coefficient α, and the signal value X_{4-(p, q)}, obtains the signal value X_{2-(p, q)} for the (p, q)-th pixel 48 based on the signal value x_{2-(p, q)}, the expansion coefficient α, and the signal value X_{4-(p, q)}, and obtains the signal value X_{3-(p, q)} for the (p, q)-th pixel 48 based on the signal value x_{3-(p, q)}, the expansion coefficient α, and the signal value X_{4-(p, q)}. Specifically, the signal processing unit 20 obtains the signal value X_{1-(p, q)}, the signal value X_{2-(p, q)}, and the signal value X_{3-(p, q)} for the (p, q)-th pixel 48 based on the expressions (1) to (3) described above.

The signal processing unit 20 expands each input signal value with the expansion coefficient α(S) as represented by the expressions (1), (2), (3), and (4). Due to this, dullness of color can be prevented. That is, the luminance of the entire image is multiplied by α. Accordingly, for example, a static image and the like can be preferably displayed with high luminance.

The luminance displayed by the output signals X_{1-(p, q)}, X_{2-(p, q)}, X_{3-(p, q)}, and X_{4-(p, q)} in the (p, q)-th pixel 48 is expanded at an expansion rate that is α times the luminance formed by the input signals x_{1-(p, q)}, x_{2-(p, q)}, and x_{3-(p, q)}. Accordingly, the display device 10 may reduce the luminance of the pixel in the surface light source device 50 based on the expansion coefficient α so as to cause the luminance to be the same as that of the pixel 48 that is not expanded. Specifically, the luminance of the surface light source device 50 may be multiplied by (1/α).

As described above, the display device 10 according to the embodiment sets the limit value β to maintain display quality, and thereby achieving low power consumption. By maintaining the luminance of the surface light source device 50, high display luminance can be achieved without deteriorating the display quality.

### Scaling Up or Down Image in One Frame

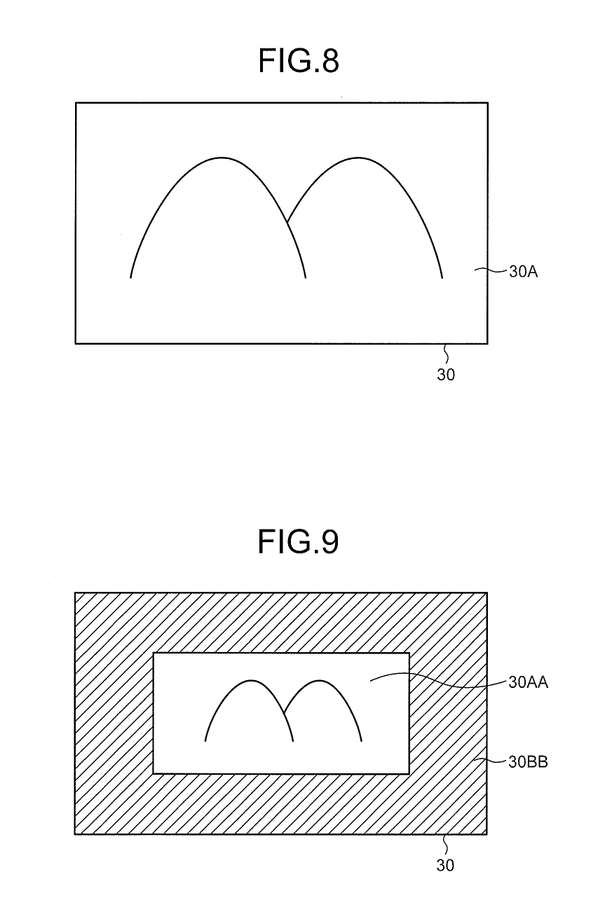

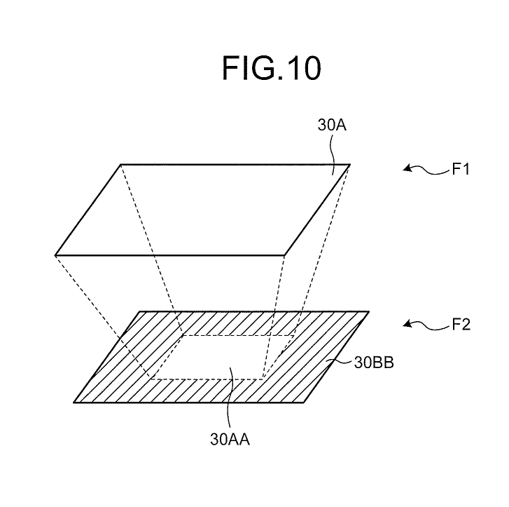

FIG. 8 is an explanatory diagram illustrating an image of the input signal, which is an example of information in one frame. FIG. 9 is an explanatory diagram illustrating an image of the input signal, which is an example of the information in one frame. FIG. 10 is an explanatory diagram illustrating a relation between information in the frame illustrated in FIG. 8 and information in the frame illustrated in FIG. 9. The display device 10 normally displays the information in one frame in an all-pixels region 30A including all pixels of the image display panel (display unit) 30. Assuming that the frame illustrated in FIG. 8 is F1 and the frame illustrated in FIG. 9 is F2, as illustrated in FIG. 10, the information in the frame F1 illustrated in FIG. 8 displayed in the all-pixels region 30A may be scaled down to be displayed in a first image display region 30AA as the information in the frame F2 illustrated in FIG. 9, and a second image display region 30BB surrounding the first image display region 30AA may be displayed. The second image display region 30BB is, for example, a region displaying black. The information displayed in the first image display region 30AA is information of a scaled-down image of the information in the frame F1 illustrated in FIG. 8 displayed in the all-pixels region 30A. The embodiment describes an example in which the image is scaled down from the frame F1 to frame F2 illustrated in FIG. 10, and the same applies to an example in which the image is scaled up from the frame F2 to the frame F1.

As illustrated in FIG. 10, when the image is scaled down from the frame F1 to the frame F2, the second image display region 30BB is displayed. The display device 10 displays the second image display region 30BB together with the first image display region 30AA, and thereby can intuitively indicate that the information of the image in the frame F1 illustrated in FIG. 8 is scaled down. The second image display region 30BB surrounds the periphery of the image in the first image display region 30AA with a black frame and the like to be identified. In this case, if the population of pixels to be analyzed is assumed to be all of the pixels 48 in determining the expansion coefficient α, the expansion coefficient α is changed by influence of the information of pixels 48 positioned in the second image display region 30BB as a frame portion. Accordingly, although the image in the frame F1 is the same as the image in the frame F2, the brightness of the image displayed across the frame F1 and the frame F2 may be changed before and after scaling (resizing) the image.

For example, the signal processing unit 20 sets a percentage of the number of pixels that are allowed to protrude from the extended color space to the number of all pixels to 3% as the limit value β. Regarding the information on the image in the frame F1 displayed in the all-pixels region 30A, for example, if it is assumed that a percentage of a display pixel region of 255 gradation value of the first sub-pixel 49R is 1.2%, a percentage of a display pixel region of 240 gradation value of the first sub-pixel 49R is 1.2%, a percentage of a display pixel region of the 220 gradation value of the first sub-pixel 49R is 1.2%, a percentage of a display pixel region of the 210 gradation value of the first sub-pixel 49R is 1.2%, the remaining part is a white display region, and the respective expansion coefficients α of the gradation values 255, 240, 220, 210 are 1.1, 1.2, 1.4, and 1.6 each of which causes the corresponding display pixel region to protrude from the extended color space when the corresponding display pixel region is expanded, and if it is assumed the expansion coefficient α of the remaining part is larger than the expansion coefficients α of the gradation values 255, 240, 220, 210, a percentage of a part protruding from the extended color space is 1.2% that corresponds only to the percentage of the of 255 gradation value when α=1.1. When the value of α is gradually increased in order of 1.2, 1.3, 1.4, and 1.5, the percentage of the part protruding from the extended color space exceeds 3% when α=1.4. In this case, regarding the information on the image in the frame F1 displayed in the all-pixels region 30A, the display pixel regions of the 255 gradation value, the 240 gradation value, and the 220 gradation value protrude from the extended color space. Accordingly, an appropriate value of α to be applied is 1.3. The all-pixels region 30A may include a plurality of regions which have the same gradation value (the same pixel value) and are separated from each other. For example, the display pixel region of the 255 gradation value may consist of a plurality of regions separated from each other. In this case, the percentage of the display pixel region of the 255 gradation value to the all-pixels region 30A (1.2% in the above example) is a total value of percentages of the plurality of regions. The same applies to the display pixel regions of the other gradation values

Similarly, the signal processing unit 20 sets the percentage of the number of pixels that are allowed to protrude from the extended color space to the number of all pixels to 3% as the limit value β. The image in the frame F2 displayed in the first image display region 30AA is scaled down as compared with the image in the frame F1 displayed in the all-pixels region 30A, so that the following case is considered, for example: a percentage of the display pixel region of 255 gradation value of the first sub-pixel 49R is 0.8%, a percentage of the display pixel region of 240 gradation value of the first sub-pixel 49R is 0.8%, a percentage of the display pixel region of the 220 gradation value of the first sub-pixel 49R is 0.8%, a percentage of the display pixel region of the 210 gradation value of the first sub-pixel 49R is 0.8%, and the remaining part is a white display region. When the value of α is gradually increased in order of 1.1, 1.2, 1.3, 1.4, and 1.5, the percentage of the part protruding from the extended color space exceeds 3% when α=1.6. In this case, regarding the information on the image in the frame F2 displayed in the first image display region 30AA, the display pixel regions of the 255 gradation value, the 240 gradation value, the 220 gradation value, and the 210 gradation value protrude from the extended color space. Accordingly, an appropriate value of α to be applied is 1.5.

In this way, although content of the image displayed across the frame F1 and the frame F2 illustrated in FIG. 10 is the same, the expansion coefficient α is changed before and after scaling up or down the image. Due to this, the image displayed across the frame F1 and the frame F2 may be different in a degree of deterioration of the displayed image.

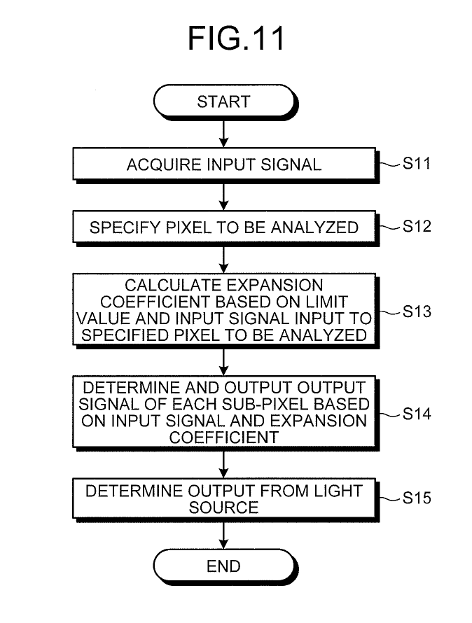

On the other hand, the display device according to the embodiment can obtain appropriate output signals for the first sub-pixel 49R, the second sub-pixel 49G, the third sub-pixel 49B, and the fourth sub-pixel 49W that displays the fourth color component even when the image is scaled up or down through color conversion processing illustrated in FIG. 11, and can reduce the change in display quality of the display device 10. Detailed description thereof will be provided hereinafter with reference to FIG. 11.

FIG. 11 is a flowchart for explaining a processing procedure of the color conversion processing according to the embodiment. In the embodiment, in the display device 10 illustrated in FIG. 1, the signal processing unit 20 receives the input signal (RGB data) from the image output unit 12 of the control device 11, and acquires the input signal (Step S11). Next, the signal processing unit 20 extracts (specifies) pixels to be analyzed. For example, in the color conversion processing on the information on the frame F2, the signal processing unit 20 extracts only the information on the first image display region 30AA that is a certain region in one frame illustrated in FIG. 9 from the acquired input signal. To extract only the information on the first image display region 30AA that is the certain region in one frame illustrated in FIG. 9 from the acquired input signal, the signal processing unit 20 acquires partition information for partitioning the first image display region 30AA, which is the certain region, from the image output unit 12 of the control device 11, and specifies the first image display region 30AA based on the partition information. In this way, the signal processing unit 20 specifies pixels 48 that display the first image display region 30AA as pixels to be analyzed (Step S12).

Next, the signal processing unit 20 calculates the expansion coefficient α based on the input signal input to the specified pixel 48 to be analyzed and the limit value β (Step S13). The signal processing unit 20 then determines and outputs the output signal for each sub-pixel 49 in all pixels 48 based on the input signal and the expansion coefficient (Step S14).

Subsequently, the signal processing unit 20 further determines an output from the light source (Step S15). That is, the signal processing unit 20 outputs the expanded output signal to the image display panel drive circuit 40, and outputs an output condition of a surface light source (surface light source device 50) that is calculated corresponding to the expansion result to the surface-light-source-device control circuit 60 as a surface-light-source-device control signal.

The following describes the color conversion processing according to the embodiment being applied to the example described above. For example, the signal processing unit 20 sets the percentage of the number of pixels that are allowed to protrude from the extended color space to the number of pixels extracted to be analyzed to 3% as the limit value β. The image in the frame F2 displayed in the first image display region 30AA is scaled down as compared with the image in the frame F1 displayed in the all-pixels region 30A. However, when only the first image display region 30AA is extracted, the percentage of each of the display pixel regions of gradation values to the extracted region (to the number of the extracted pixels) is the same as that of the information on the image in the frame F1 displayed in the all-pixels region 30A. For example, assuming that the percentage of the display pixel region of 255 gradation value of the first sub-pixel 49R is 1.2%, the percentage of the display pixel region of 240 gradation value of the first sub-pixel 49R is 1.2%, the percentage of the display pixel region of the 220 gradation value of the first sub-pixel 49R is 1.2%, the percentage of the display pixel region of the 210 gradation value of the first sub-pixel 49R is 1.2%, and the remaining part is a white display region, the percentage of a part protruding from the extended color space is 1.2% that corresponds only to the percentage of the display pixel region of 255 gradation value when α=1.1. When the value of α is gradually increased in order of 1.2, 1.3, 1.4, and 1.5, the percentage of the part protruding from the extended color space exceeds 3% when α=1.4. In this case, regarding the information on the image in the frame F2 displayed in the first image display region 30AA, the display pixel regions of the 255 gradation value, the 240 gradation value, and the 220 gradation value protrude from the extended color space. The limit value β is set to 3% herein, so that the appropriate value of α to be applied is 1.3 prior to 1.4. As a result, the expansion coefficient α is not changed before and after scaling up or down the image, and the change such as deterioration in display quality including gradation loss and the like is suppressed. That is, even when principal image information is scaled up or down in consecutive display states, the expansion coefficient α is maintained constant by causing the information to be analyzed to be substantially the same, so that the display quality is not deteriorated. Even when an amount of information to be analyzed may be slightly varied as the image information is scaled up or down, influence on the expansion coefficient α is small and can be negligible.

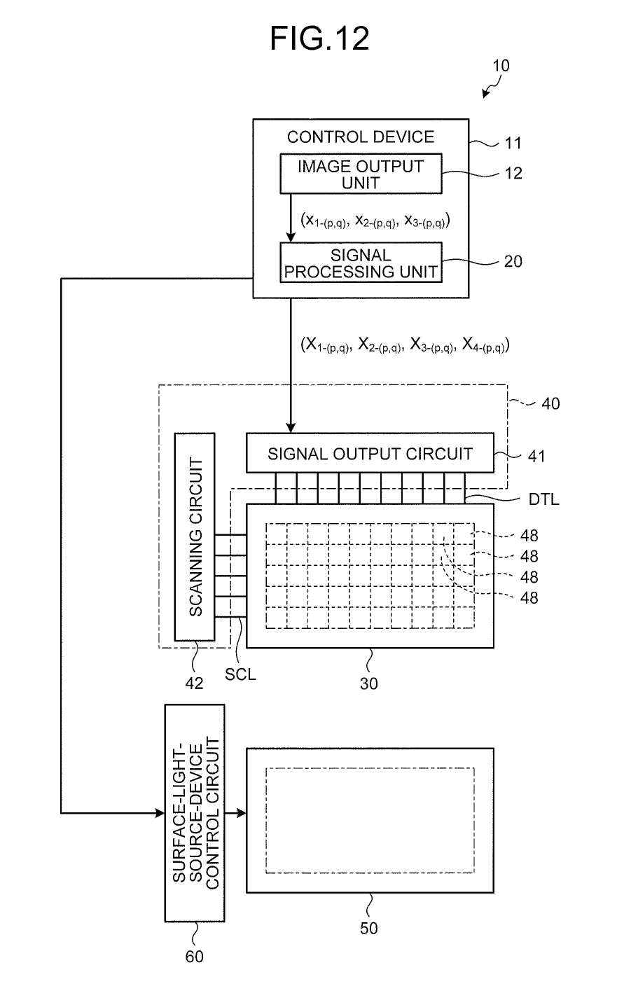

At Step S12, to extract only the information on the first image display region 30AA that is the certain region in one frame illustrated in FIG. 9 from the acquired input signal, the signal processing unit 20 may acquire ratio information about a scaling ratio of the first image display region 30AA, which is the certain region, from the image output unit 12 of the control device 11, and may specify the first image display region 30AA based on the ratio information. FIG. 12 is a block diagram illustrating another example of the configuration of the display device according to the embodiment. As illustrated in FIG. 12, the signal processing unit 20 may be part of the control device 11. When the signal processing unit 20 is part of the control device 11, at Step S12, to extract only the information on the first image display region 30AA that is the certain region in one frame illustrated in FIG. 9 from the acquired input signal, the signal processing unit 20 acquires partition information for partitioning the first image display region 30AA, which is the certain region, from the image output unit 12, and specifies the first image display region 30AA based on the partition information, only through processing within the control device 11. In this way, the signal processing unit 20 can specify the pixels 48 that display the first image display region 30AA as the pixels to be analyzed.

### Modification

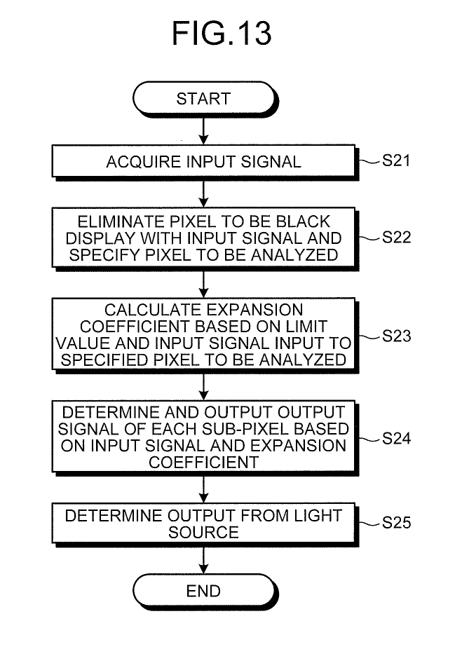

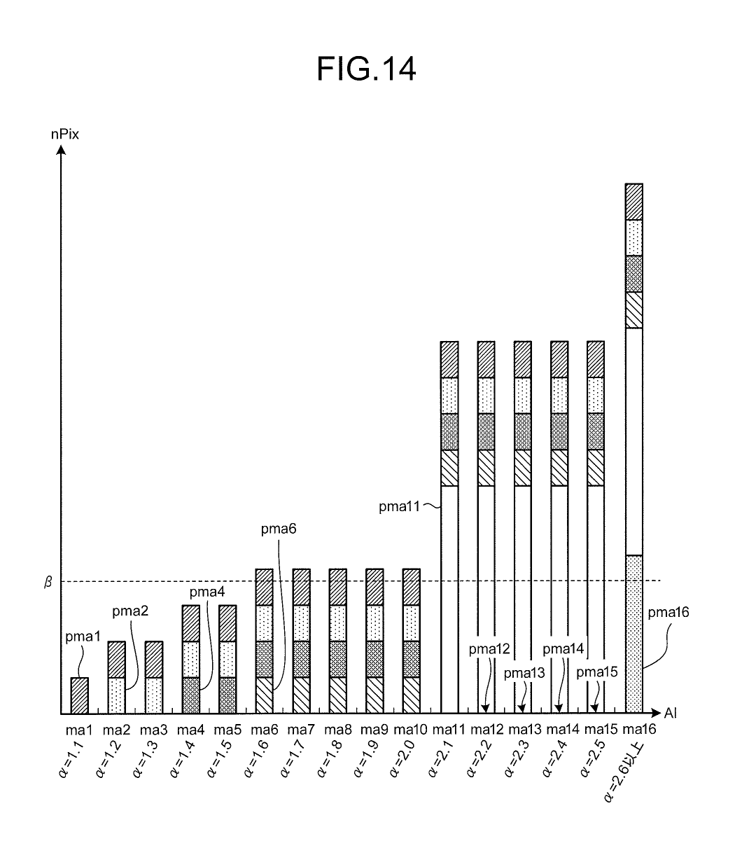

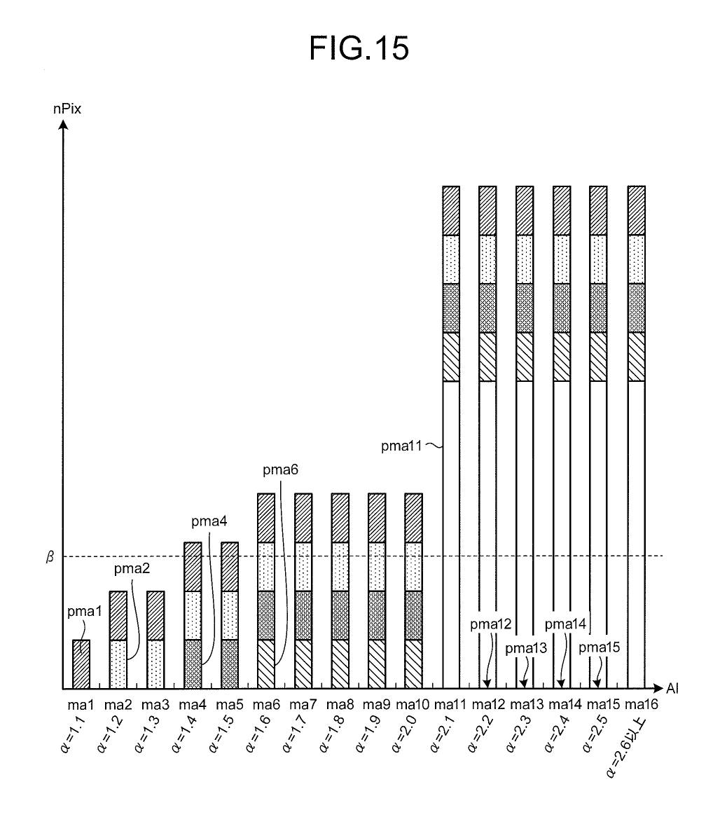

FIG. 13 is a flowchart for explaining a processing procedure of the color conversion processing according to a modification of the embodiment. FIG. 14 is a diagram for explaining cumulative frequency distribution using the expansion coefficient as a variable when the information in one frame illustrated in FIG. 9 is displayed by each pixel. FIG. 15 is a diagram for explaining cumulative frequency distribution using the expansion coefficient as a variable when the information in one frame illustrated in FIG. 8 is displayed by each pixel. The display device 10 may perform the processing procedure of the color conversion processing illustrated in FIG. 13.

As illustrated in FIG. 13, in the modification of the embodiment, in the display device 10 illustrated in FIG. 1, the signal processing unit 20 receives the input signal (RGB data) from the image output unit 12 of the control device 11, and acquires the input signal (Step S21).

To extract only the information on the first image display region 30AA that is the certain region in one frame illustrated in FIG. 9 from the acquired input signal, the signal processing unit 20 eliminates at least the information on a pixel 48 having gradation to be black display from the acquired input signal, or eliminates the pixel 48 having the gradation to be black display from the population of pixels 48 to be analyzed in calculating the limit value β, and specifies the first image display region 30AA. In this way, the signal processing unit 20 specifies the pixels 48 that display the first image display region 30AA as the pixels to be analyzed (Step S22).

Next, the signal processing unit 20 calculates the expansion coefficient α based on the input signal inputs to the specified pixels 48 to be analyzed and the limit value β (Step S23). The signal processing unit 20 then determines and outputs the output signal of each sub-pixel 49 in all pixels 48 based on the input signals and the expansion coefficient (Step S24).

Subsequently, the signal processing unit 20 further determines the output from the light source (Step S25). That is, the signal processing unit 20 outputs the expanded output signal to the image display panel drive circuit 40, and outputs the output condition of the surface light source (surface light source device 50) that is calculated corresponding to the expansion result to the surface-light-source-device control circuit 60 as the surface-light-source-device control signal.

The processing by the signal processing unit 20 according to the embodiment will be described below as compared with the conventional method. First, the following describes the image information on the frame F1 displayed as the all-pixels region 30A in FIG. 8. As illustrated in FIG. 15, for each of a plurality of classifications (for example, classifications equally divided into 16) ma1 to ma16 using the expansion coefficient α as a variable, the signal processing unit 20 calculates a cumulative frequency nPix(%) of the percentage of pixels (regions) which protrudes from the extended color space when being expanded by α corresponding to each classification. In FIG. 15, each of pma1 to pma15 schematically represents a percentage of a corresponding display pixel region that protrudes from the extended color space when the display pixel region is expanded by α of each classification.

The signal processing unit 20 sets the percentage of the number of pixels that are allowed to protrude from the extended color space to the number of all pixels to 3% as the limit value β as illustrated in FIG. 15. Regarding the information on the image in the frame F1 displayed in the all-pixels region 30A, for example, it is assumed that a percentage of a display pixel region of 255 gradation value of the first sub-pixel 49R is 1.2% (pma1 in FIG. 15), a percentage of a display pixel region of 240 gradation value of the first sub-pixel 49R is 1.2% (pma2 in FIG. 15), a percentage of a display pixel region of the 220 gradation value of the first sub-pixel 49R is 1.2% (pma4 in FIG. 15), a percentage of a display pixel region of the 210 gradation value of the first sub-pixel 49R is 1.2% (pma6 in FIG. 15), the remaining part is a white display region, and the respective expansion coefficients α of the gradation values 255, 240, 220, 210 are 1.1, 1.2, 1.4, and 1.6 each of which causes the corresponding display pixel region to protrude from the extended color space when the corresponding display pixel region is expanded, and it is assumed the expansion coefficient α of the remaining part is larger than the expansion coefficients α of the gradation values 255, 240, 220, 210. When the signal processing unit 20 gradually increases the value of α in order of 1.1, 1.2, 1.3, 1.4, and 1.5, the percentage of the part protruding from the extended color space exceeds 3% when α=1.4 (refer to the classification ma4 in FIG. 15). In this case, regarding the information on the image in the frame F1 displayed in the all-pixels region 30A, the display pixel regions of the 255 gradation value, the 240 gradation value, and the 220 gradation value protrude from the extended color space. Accordingly, an appropriate value of α to be applied is 1.3. In this modification, the all-pixels region 30A may include a plurality of regions which have the same gradation value (the same pixel value) and are separated from each other. For example, the display pixel region of the 255 gradation value may consist of a plurality of regions separated from each other. In this case, the percentage of the display pixel region of the 255 gradation value to the all-pixels region 30A (1.2% in the above example) is a total value of percentages of the plurality of regions. The same applies to the display pixel regions of the other gradation values

The following describes the image information in the frame F2 illustrated in FIG. 9. The first image display region 30AA is scaled down as compared with the information of the image in the frame F1 displayed in the all-pixels region 30A. In this case, the signal processing unit 20 calculates the cumulative frequency distribution as illustrated in FIG. 14. As illustrated in FIG. 14, similarly to the case of the all-pixels region 30A, the signal processing unit 20 sets the percentage of the number of pixels that are allowed to protrude from the extended color space to the number of all pixels to 3% as the limit value β. The image in the frame F2 displayed in the first image display region 30AA is scaled down as compared with the image in the frame F1 displayed in the all-pixels region 30A, so that, as compared with the case of the all-pixels region 30A, a percentage of the display pixel region of 255 gradation value of the first sub-pixel 49R is 0.8% (pma1 in FIG. 14), a percentage of the display pixel region of 240 gradation value of the first sub-pixel 49R is 0.8% (pma2 in FIG. 14), a percentage of the display pixel region of the 220 gradation value of the first sub-pixel 49R is 0.8% (pma4 in FIG. 14), and a percentage of the display pixel region of the 210 gradation value of the first sub-pixel 49R is 0.8% (pma6 in FIG. 14). When the signal processing unit 20 gradually increases the value of α in order of 1.1, 1.2, 1.3, 1.4, and 1.5, the percentage of the part protruding from the extended color space exceeds 3% when α=1.6 (refer to the classification ma6 in FIG. 14). In this case, regarding the information on the image in the frame F2 displayed in the first image display region 30AA, the display pixel regions of the 255 gradation value, the 240 gradation value, the 220 gradation value, and the 210 gradation value protrude from the extended color space. Accordingly, an appropriate value of α to be applied is 1.5. That is, the α-value is different from that of the image in the all-pixels region 30A described above, so that the degree of deterioration of the image is unfortunately different therefrom.

In the embodiment, at Step S22, the signal processing unit 20 extracts only the information on the first image display region 30AA that is the certain region in the frame F2 illustrated in FIG. 9. Due to this, the signal processing unit 20 eliminates at least the information on a pixel having the gradation to be black display from the information on the frame F2, or eliminates the pixel 48 having the gradation to be black display from the population of pixels to be analyzed in calculating the limit value β. As a result, the information on the image extracted by the signal processing unit 20 is in the same state as FIG. 15, and the value of α calculated by the signal processing unit 20 is kept the same as in the case of the all-pixels region 30A.

The modification of the embodiment describes a case in which the second image display region 30BB is the black display region. However, the second image display region 30BB is not limited to a region only having a gradation value of black, and may be a region having gradation values between a gradation value of white and a gradation value of black. For example, a gradation value of {(the number of gradations)×(⅛)} or less (for example, a gradation value of 32 or less when the number of gradations that can be displayed is 256 gradations), and preferably a gradation value of {(the number of gradations)×( 1/24)} or less (for example, a gradation value of 8 or less when the number of gradations that can be displayed is 256 gradations) may be considered as black, and regions of these gradation values considered as black may be also processed as the second image display region 30BB. Display information on the second image display region 30BB other than the above can be discriminated from the information on the first image display region 30AA so long as it is determined in advance.

As described above, the display device 10 according to the embodiment and the modification thereof calculates each output signal based on a result obtained by extracting and analyzing only the information on the first image display region 30AA as the certain region in one frame F2 from the input signal. Accordingly, the display device 10 according to the embodiment and the modification thereof obtains appropriate output signals of the first sub-pixel 49R, the second sub-pixel 49G, the third sub-pixel 49B, and the fourth sub-pixel 49W that displays the fourth color component even when the image is scaled up or down, and reduces the change in display quality of the display device 10. A current value consumed by the surface light source device 50 is reduced as the luminance is enhanced by the fourth sub-pixel 49W, which can reduce power consumption or achieve high display luminance.

In the display device 10, when there is the second image display region 30BB such as the input frame F2, the signal processing unit 20 outputs the output signal based on the result obtained by extracting and analyzing the first image display region 30AA as the information on the certain region. In the display device 10, when there is no second image display region 30BB such as the input frame F1, the signal processing unit 20 outputs the output signal based on the result obtained by extracting and analyzing all pixels 48 of the image display panel (display unit) 30 as the information on the certain region. As a result, according to the embodiment, when the image is scaled down from the frame F1 to the frame F2 illustrated in FIG. 10 or even when the image is scaled up from the frame F2 to the frame F1, appropriate output signals of the first sub-pixel, the second sub-pixel, the third sub-pixel, and the fourth sub-pixel that displays the fourth color component can be obtained to reduce the change in display quality of the display device.

### Application Example

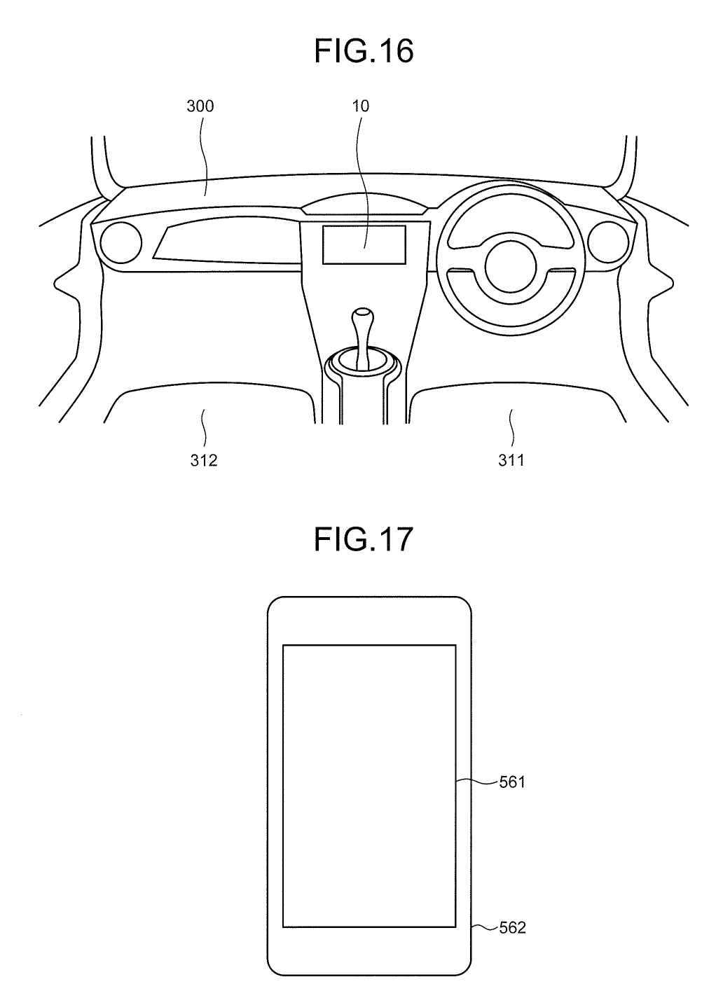

Next, the following describes an application example of the display device 10 described in the embodiment and the modification thereof with reference to FIGS. 16 and 17. FIGS. 16 and 17 are diagrams illustrating an example of an electronic apparatus including the display device according to the embodiment. The display device 10 according to the embodiment can be applied to electronic apparatuses in various fields such as a car navigation system illustrated in FIG. 16, a television apparatus, a digital camera, a notebook-type personal computer, a portable electronic apparatus such as a cellular telephone illustrated in FIG. 17, or a video camera. In other words, the display device 10 according to the embodiment can be applied to electronic apparatuses in various fields that display a video signal input from the outside or a video signal generated inside as an image or a video. The electronic apparatus includes the control device 11 (refer to FIG. 1) that supplies the video signal to the display device to control an operation of the display device.

The electronic apparatus illustrated in FIG. 16 is a car navigation device to which the display device 10 according to the embodiment and the modification thereof is applied. The display device 10 is arranged on a dashboard 300 in an automobile. Specifically, the display device 10 is arranged on the dashboard 300 and between a driver's seat 311 and a passenger seat 312. The display device 10 of the car navigation device is used for displaying navigation, displaying a music operation screen, or reproducing and displaying a movie.

The electronic apparatus illustrated in FIG. 17 is an information portable terminal, to which the display device 10 according to the embodiment and the modification thereof is applied, that operates as a portable computer, a multifunctional mobile phone, a mobile computer allowing a voice communication, or a communicable portable computer, and may be called a smartphone or a tablet terminal in some cases. This information portable terminal includes a display unit 562 on a surface of a housing 561, for example. The display unit 562 includes the display device 10 according to the embodiment and the modification thereof and a touch detection (what is called a touch panel) function that can detect an external proximity object.

The embodiment is not limited to the above description. The components according to the embodiment described above include a component that is easily conceivable by those skilled in the art, substantially the same component, and what is called an equivalent. The components can be variously omitted, replaced, and modified without departing from the gist of the embodiment described above.

### Aspects of Present Disclosure

The present disclosure includes the following aspects.

(1) A display device comprising:

a display unit including a plurality of pixels arranged therein, the pixels including a first sub-pixel that displays a first color component, a second sub-pixel that displays a second color component, a third sub-pixel that displays a third color component, and a fourth sub-pixel that displays a fourth color component different from the first sub-pixel, the second sub-pixel, and the third sub-pixel; and

a signal processing unit that calculates output signals corresponding to the first sub-pixel, the second sub-pixel, the third sub-pixel, and the fourth sub-pixel based on input signals corresponding to the first sub-pixel, the second sub-pixel, and the third sub-pixel, wherein

the signal processing unit calculates each of the output signals based on a result obtained by extracting and analyzing only information on a certain region within one frame from the input signals.

(2) The display device according to (1), wherein, when information of the one frame includes a first image display region and a second image display region surrounding the first image display region, the certain region is the first image display region.

(3) The display device according to (2), wherein the signal processing unit assumes that the certain region is a region displayed with all pixels of the display unit when there is no second image display region.

(4) The display device according to (1), wherein the information of the certain region is information of a region excluding at least a pixel for displaying black.

(5) The display device according to (4), wherein a gradation value of the black is {(the number of gradations that can be displayed)×(⅛)} or less.

What is claimed is:

1. A display device comprising:
a display unit including a plurality of pixels arranged therein, the pixels including a first sub-pixel that displays a first color component, a second sub-pixel that displays a second color component, a third sub-pixel that displays a third color component, and a fourth sub-pixel that displays a fourth color component different from the first sub-pixel, the second sub-pixel, and the third sub-pixel; and
a signal processing unit that calculates output signals corresponding to the first sub-pixel, the second sub-pixel, the third sub-pixel, and the fourth sub-pixel based on input signals corresponding to the first sub-pixel, the second sub-pixel, and the third sub-pixel, wherein
the signal processing unit calculates each of the output signals based on a result obtained by extracting and analyzing only information on a certain region within one frame from the input signals.

2. The display device according to claim 1, wherein, when information of the one frame includes a first image display region and a second image display region surrounding the first image display region, the certain region is the first image display region.

3. The display device according to claim 2, wherein the signal processing unit assumes that the certain region is a region displayed with all pixels of the display unit when there is no second image display region.

4. The display device according to claim 1, wherein the information of the certain region is information of a region excluding at least a pixel for displaying black.

5. The display device according to claim 4, wherein a gradation value of the black is {(the number of gradations that can be displayed)×(⅛)} or less.
